(19) United States
(12) Patent Application Publication
(10) Pub. No.: US 2026/0145116 A1
(43) Pub. Date: May 28, 2026

(54) METHODS AND SYSTEM FOR PRODUCING CO2 ENRICHED STREAMS FROM AIR STREAMS

(71) Applicant: UOP LLC, Des Plsines, IL (US)

(72) Inventors: Elmira Ghanbari, Buffalo Grove, IL (US); Pourang Shamsi, Richmond, TX (US)

(21) Appl. No.: 19/310,491

(22) Filed: Aug. 26, 2025

Related U.S. Application Data
(60) Provisional application No. 63/725,068, filed on Nov. 26, 2024.

(51) Int. Cl. B01D 53/047; B01D 53/04; B01D 53/26; C01B 32/50

(52) U.S. Cl. CPC B01D 53/047; B01D 53/0462; B01D 53/261; C01B 32/50; B01D 2253/104; B01D 2253/106; B01D 2253/116; B01D 2256/10; B01D 2256/22; B01D 2257/80; B01D 2258/06

(57) ABSTRACT

Processes and systems for providing a CO₂ enriched stream from an air stream, by: selectively adsorbing, in a first separation zone, CO₂ and H₂O in an air stream and providing a CO₂ and H₂O depleted gas stream; separating, in a second separation zone, the CO₂ and H₂O depleted gas stream and providing an N₂ enriched stream, an O₂ enriched stream, and an N₂ enriched regeneration stream; heating the N₂ enriched regeneration stream to provide a heated N₂ enriched regeneration stream; selectively desorbing, in the first separation zone, the CO₂ and H₂O using the heated N₂ enriched regeneration stream and providing a spent regeneration gas stream; drying the spent regeneration gas stream to remove H₂O and providing a dried spent regeneration gas stream; and separating, in a third separation zone, the CO₂ from the dried spent regeneration gas stream to provide a CO₂ enriched stream.

### RELATED APPLICATIONS

This application claims priority to U.S. Provisional Patent Application Ser. No. 63/725,068, filed on Nov. 26, 2024, the entire disclosure of which is incorporated herein by reference.

### FIELD OF THE INVENTION

This invention relates generally to processes and systems for producing CO₂ enriched streams from air streams.

### BACKGROUND OF THE INVENTION

Over the last approximately one hundred and thirty years, atmospheric CO₂ levels have increased from 300 ppm to over 400 ppm, which matches the global temperature increase of approximately 2 degrees Fahrenheit. Atmospheric CO₂ is recognized to be the primary reason behind undesirable climate pattern changes.

Strategies for CO₂ mitigation and negative emissions have received considerable attention. Direct air capture (DAC) has been given serious consideration as one of the main “negative carbon emission” technologies for the reduction of the atmospheric concentration of CO₂. In DAC processes, greenhouse gases are directly captured from the atmosphere. The most advanced technologies for DAC processes use thermal cycles in which an adsorbent selectively captures CO₂ from the atmosphere, then the adsorbent undergoes a thermal process thereby releasing pure CO₂ and regenerating the adsorbent. To date, only twenty-seven DAC plants are operating worldwide, capturing nearly 0.01 MtCO₂/year. The Net Zero Emissions by 2050 (NZE) Scenario envisions an ambitious scale-up of DAC, projecting to capture almost 60 Mt CO₂/year by 2030. Achieving this significant expansion is feasible, yet it demands the establishment of several more large-scale demonstration plants to refine the technology and reduce capture costs. These facilities will play a crucial role in refining the technology and decreasing costs, making widespread DAC deployment more economically viable and contributing significantly to global carbon reduction efforts.

Accordingly, it would be desirable to have more effective and efficient ways of modifying current and known processes gas separation processes with DAC processes to capture more CO₂.

### SUMMARY OF THE INVENTION

The present inventors have developed processes and systems for producing CO₂ enriched streams from air streams. The processes and systems described herein may be modifications to, or replacements of, existing air separation plants to reduce the CO₂ footprint and to enhance the profitability of the DAC projects by producing CO₂ enriched streams, oxygen streams, and nitrogen streams from an air stream to effectively optimize cost efficiency in carbon capture, aligning with the Triple Bottom Line (TBL) sustainability objectives.

The air separation plants market is anticipated to reach approximately $8.5 billion by 2028, with a projected Compound Annual Growth Rate (CAGR) of 5%. Over the medium term, the market is poised for significant expansion, driven by rising demand for industrial gases. This demand surge is particularly fueled by the robust growth in steel and process industries, establishing a strong foundation for sustained market growth throughout the forecast period. As such, it would be desirable to modify air separation plants for CO₂ removal.

Air separation plants typically employ a variety of processes to separate the components of air, primarily nitrogen, oxygen, and argon. The most common process used is cryogenic air separation units (ASUs), which employ cryogenic distillation as the primary means of gas separation, which takes advantage of the different boiling points of these gases. In ASUs, the regenerative adsorbent for CO₂ removal is most frequently used technology in the pretreatment of the air. Contributing to the efficiency of air separation processes, Honeywell UOP offers specialized adsorbent materials tailored for use in the air separation process including but not limited to 13X-APG, APG-III, APG-V, D-201, and A-201. These adsorbents are designed to exhibit specific adsorption characteristics that enhance the overall effectiveness of the separation process within air separation plants. During the regeneration process of these adsorbents, the first desorbed species is high-concentration CO₂. Presently, in most air separation plants, including ASUs, gases used to regenerate the adsorbents are vented to the atmosphere as waste gas.

In one aspect, the processes and systems disclosed herein are modifications to, or replacements of, existing air separation plants, including ASUs, to produce enriched CO₂ streams for capture or further processing. Contemporary air separation units demonstrate remarkable capabilities, generating up to 6,000 tons per day (t/d) of oxygen and 10,000 t/d of nitrogen. In the context of multi-train air separation plants, where multiple units operate concurrently, the collective production rates can reach to 30,000 t/d of oxygen. To obtain the capacity of 6,000 t/d oxygen, a minimum of 28,571 t/d air needs to be processed which carries about 11.5 t/d CO₂ that needs to be removed in the process. Considering the minimum of 20,000 ASUs running globally, upgrading these plants by adding dryers and CO₂ fractionators, 83.4 Mt CO₂/year could be captured. This amount is much larger than 60 MtCO₂/year that envisioned by NZE by 2030.

Therefore, the present invention may be characterized, in at least one aspect, as providing a process of providing a CO₂ enriched stream from an air stream by selectively adsorbing, in a first separation zone, CO₂ and H₂O in an air stream and providing a CO₂ and H₂O depleted gas stream; separating, in a second separation zone, the CO₂ and H₂O depleted gas stream and providing an N₂ enriched stream, an O₂ enriched stream, and an N₂ enriched regeneration stream; heating the N₂ enriched regeneration stream to provide a heated N₂ enriched regeneration stream; selectively desorbing, in the first separation zone, the CO₂ and H₂O using the heated N₂ enriched regeneration stream and providing a spent regeneration gas stream; drying the spent regeneration gas stream to remove H₂O and providing a dried spent regeneration gas stream; and separating, in a third separation zone, the CO₂ from the dried spent regeneration gas stream to provide a CO₂ enriched stream.

The dried spent regeneration gas stream may be cooled using one or more streams from the second separation zone, the one or more streams having a temperature lower than the dried spent regeneration gas stream.

The first separation zone may be a temperature swing adsorption (TSA) zone including solid adsorbent.

The solid adsorbent may have a higher affinity for H₂O than CO_{2.} The solid adsorbent may be selected from a group consisting of alumina, silica gel, molecular sieves, and mixtures thereof.

The second separation zone may comprise one or more distillation columns.

The third separation zone may be a pressure swing adsorption (PSA) zone.

The third separation zone may comprise one or more distillation columns.

The CO₂ enriched stream in the third separation zone may be liquefied.

An N₂ enriched byproduct stream may be provided in the third separation zone.

When a CO₂ concentration of the spent regeneration gas stream is at a predetermined level, the spent regeneration gas stream may be passed to a further downstream process when the CO₂ concentration of the spent regeneration gas stream is at the predetermined level.

The present invention may be also characterized, in at least another aspect, as providing a CO₂ enriched stream from an air stream by passing an air stream to a first separation zone configured to selectively adsorb CO₂ and H₂O and provide a CO₂ and H₂O depleted gas stream; passing the CO₂ and H₂O depleted gas stream to a second separation zone configured to provide an N₂ enriched stream, an O₂ enriched stream, and an N₂ enriched regeneration stream; passing the N₂ enriched regeneration stream to a first heating zone to provide a heated N₂ enriched regeneration stream; passing the heated N₂ enriched regeneration stream to the first separation zone, the first separation zone further configured to selectively desorb the CO₂ and H₂O and provide a spent regeneration gas stream; passing the spent regeneration gas stream to a drying zone configured to remove H₂O and provide a dried spent regeneration gas stream; and passing the dried spent regeneration gas stream to a third separation zone configured to provide a CO₂ enriched stream.

One or more streams from the second separation zone may be passed to a first heat exchanger, the first heat exchanger configured to cool the dried spent regeneration gas stream.

The first separation zone may be a temperature swing adsorption (TSA) zone including a solid adsorbent.

The third separation zone may provide a liquefied CO₂ enriched stream.

The third separation zone may be a pressure swing adsorption (PSA) zone.

The third separation zone may provide an N₂ enriched byproduct stream.

The present invention may be further characterized, in at least another aspect, as providing a system for producing a CO₂ enriched stream from an air stream, the system may comprise: a first separation zone configured to receive an air stream and selectively adsorb CO₂ and H₂O and provide a CO₂ and H₂O depleted gas stream; a second separation zone configured to receive the CO₂ and H₂O depleted gas stream and provide an N₂ enriched stream, an O₂ enriched stream, and an N₂ enriched regeneration stream; a first heater configured to heat the N₂ enriched regeneration stream; the first separation zone further configured to receive the heated N₂ enriched regeneration stream to selectively desorb the CO₂ and H₂O and provide a spent regeneration gas stream; a dryer configured to receive the spent regeneration gas stream to remove H₂O and provide a dried spent regeneration gas stream; a third separation zone configured to receive the dried spent regeneration gas stream and provide a CO₂ enriched stream.

The system may further comprise a first heat exchanger configured to receive one or more streams from the second separation zone and cool the dried spent regeneration gas stream.

The first separation zone may be a temperature swing adsorption (TSA) zone including a solid adsorbent.

The third separation zone may be further configured to provide a liquefied CO₂ enriched stream.

The third separation zone may be a pressure swing adsorption (PSA) zone.

The third separation zone may provide an N₂ enriched byproduct stream.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

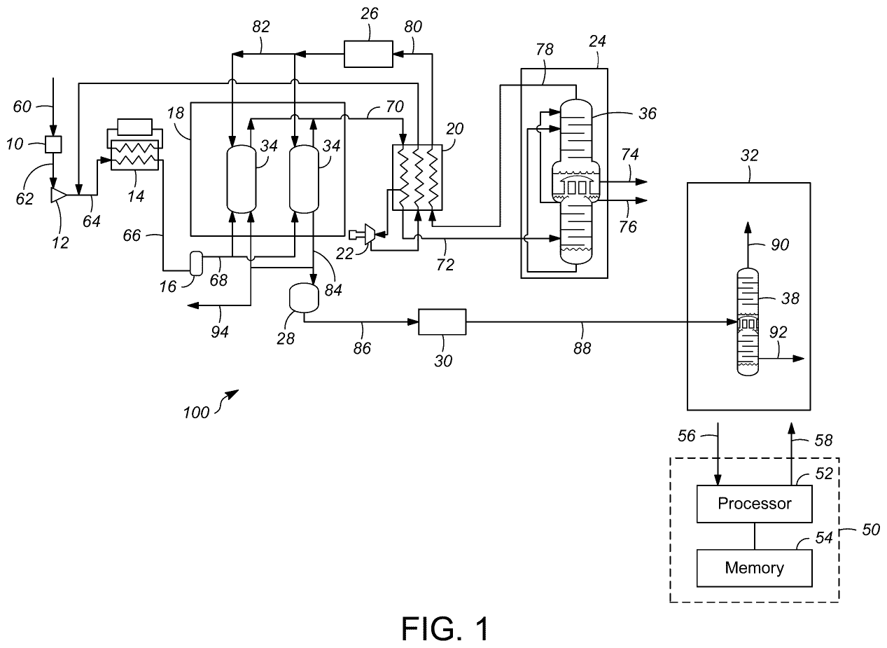

FIG. 1 shows a schematic depiction of a system according to one or more aspects of the present invention.

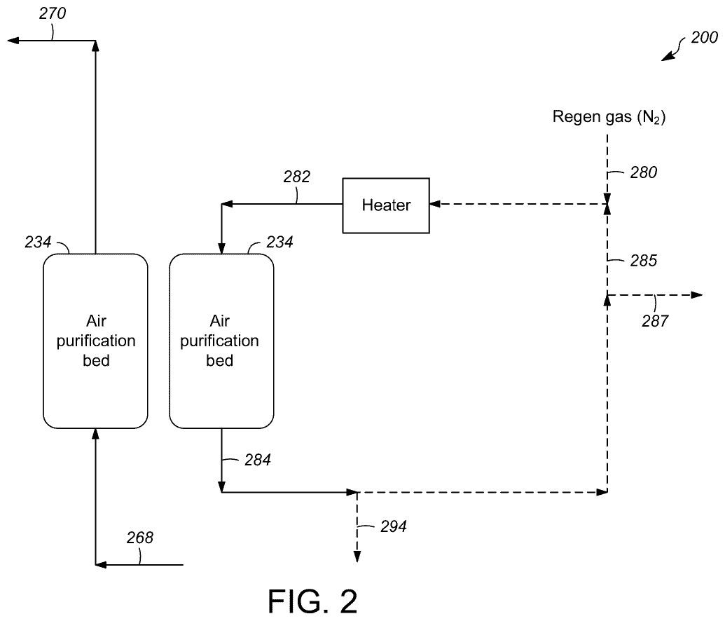

FIG. 2 shows a schematic of a two vessels in a first separation zone according to one or more aspects of the present invention.

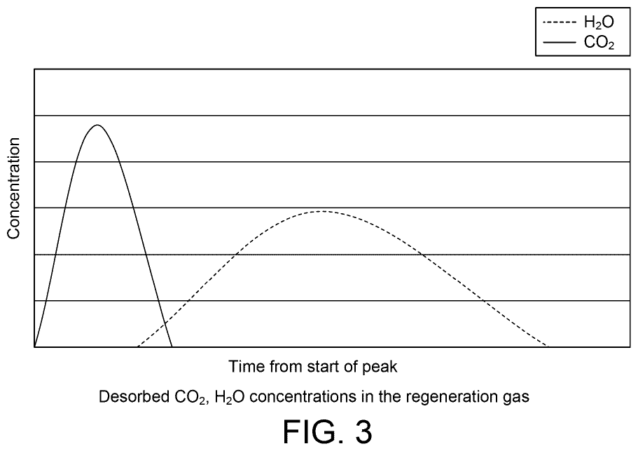

FIG. 3 shows an experimental computer simulation of the desorption of CO₂ and H₂O from solid adsorbent in a first separation zone according to one or more aspects of the present invention.

It should be appreciated and understood by those of ordinary skill in the art that various other components such as valves, pumps, etc. were not shown in the drawings as it is believed that the specifics of same are well within the knowledge of those of ordinary skill in the art and a description of same is not necessary for practicing or understating the embodiments of the present invention.

### DETAILED DESCRIPTION OF THE INVENTION

As mentioned above, processes and systems have been invented for producing CO₂ enriched streams from air streams. The processes and systems may be modifications, or replacements of, existing air separation plants to reduce the CO₂ footprint.

With these general principles in mind, one or more embodiments of the present invention will be described with the understanding that the following description is not intended to be limiting.

Turning to FIGS. 1 to 3, various embodiments of the present invention will be described which are utilized to produce CO₂ enriched streams from air streams. By “CO₂ enriched” it is meant that the stream contains at least 50% CO₂, at least 90% CO₂, or at least 95% CO₂.

Turning now to FIG. 1, an exemplary system 100 for producing a CO₂ enriched stream from an air stream may include an inlet air filter 10, an air compressor 12, a cooler 14, a water separator 16, a first separation zone 18, a first heat exchanger 20, a turboexpander 22, a second separation zone 24, a first heater 26, a dryer 28, a second heat exchanger 30, a third separation zone 32, and a controller 50. Although specific components are shown in FIG. 1 as being included in system 100, system 100 may include more or fewer components. For example, system 100 may include multiple water separators 16 in order to achieve a predetermined water content in a stream entering the first separation zone 18. Further, system 100 may integrate or separate various components shown in FIG. 1. For example, while FIG. 1 shows two air purification beds 34 in separate vessels, it is contemplated that the two air purification beds 34 may be contained within a single vessel.

As shown in FIG. 1, system 100 may include a controller 50. The controller 50 may perform a variety of functions for system 100, including functions to operate, monitor, and communicate with various components of the system 100. To carry out functions, controller 50 may include a processor 52, which may be programmed to execute code or machine-readable instructions. Processor 52 may include various types of hardware, including a CPU, a GPU, a microcontroller, and the like. In some embodiments, the code or machine-readable instructions may be stored in a memory or non-transitory medium 54. Memory 54 may also store data information regarding various components of system 100, for example, predetermined operating parameter values and ranges such as temperature, pressure, flow rate, liquid level, humidity, working capacity of solid adsorbents, chemical concentration (i.e., of an analyte or compound), and so forth.

System 100 may include one or more sensors (not shown). Sensors may be used to monitor one or more components or streams within system 100. Sensors may be, but are not limited to, gas sensors, temperature sensors, level sensors, pressure sensors, humidity sensors, flow rate sensor, chemical sensors, and so forth.

Controller 50 may receive information and data from system 100 via input signals 56 from system 100, as described in more detail herein. Controller 50 may send information and data to system 100 via output signals 58. Input signals 56 and output signals 58 may receive and send information and data, respectively, using one or more known communication technologies such as an optical fiber, a wire, a cable, a modem, a radio device, a Bluetooth® device, and so forth.

In some embodiments, input signal 56 sends information and data from one or more sensors, as described herein, within system 100 to controller 50. For example, input signal 56 may be a temperature reading from a temperature sensor (not shown) within distillation column 36. In another example, input signal 56 may be flow rate reading of N₂ enriched regeneration stream 78 from a flow rate sensor (not shown). Output signal 58 may be a control signal to control or operate one or more components of system 100. For example, output signal 58 may be a control signal to pump (not shown) in dried spent regeneration gas stream 86 to increase the gas flow rate of dried spent regeneration gas stream 86. In another example, output signal 58 may be a control signal to dryer 28 to decrease the operating temperature of dryer 28.

In one example, controller 50 receives data via input signal 56 from a chemical sensor (not shown) located in spent regeneration gas stream 84. Processor 52 may execute instructions stored in memory 54 to process the received CO₂ concentration and/or process the received data to calculate the concentration of CO₂ within the spent regeneration gas stream 84. Processor 52 may execute instructions stored in memory 54 to compare the received or calculated CO₂ concentration to a predetermined value of CO₂ concentration. If the value of the received or calculated CO₂ concentration is at or above the predetermined value of CO₂ concentration, controller 50 may send a control signal via output signal 58 to a valve (not shown) in spent regeneration gas stream 84 to direct the flow of spent regeneration gas stream 84 to dryer 28. If the value of the received or calculated CO₂ concentration is below the predetermined value of CO₂ concentration, controller 50 may send a control signal via output signal 58 to a valve (not shown) in spent regeneration gas stream 84 to direct the flow of spent regeneration gas stream 84 to stream 94 for further processing.

Still referring to FIG. 1, the inlet air filter 10 may remove undesirable contaminants present in an air stream. In some embodiments, inlet air filter 10 may be a fiberglass filter, a pleated filter, a high-efficiency particulate air (HEPA) filter, an electrostatic filter, an activated carbon filter, or a combination of one or more of the foregoing.

The air compressor 12 may compress an air stream to a predetermined temperature. In some embodiments, air compressor 12 may be a centrifugal compressor, an axial compressor, a reciprocating air compressor, a rotary screw compressor, a rotary vane air compressor, a rotary screw air compressor, or a combination of one or more of the foregoing.

The cooler 14 may cool an air stream to a predetermined temperature. In some embodiments, cooler 14 may be a heat exchanger. In some embodiments, cooler 14 may be a compressed gas cooler, an intercooler, an aftercooler, or a combination of one or more of the foregoing.

The water separator 16 may separate liquid water from an air stream. In some embodiments, the water separator 16 may reduce the concentration of water in an air stream to a predetermined level. While only one water separator 16 is shown in FIG. 1, the number of water separators 16 that may be used in system 100 is not limited, and any number of water separators 16 may be employed to reduce the concentration of water in an air stream to a predetermined level. Water separator 16 may be a compressed air water separator.

As shown in FIG. 1, the first separation zone 18 may include one or more air purification beds 34. While FIG. 1 demonstrates two air purification beds 34, any additional number of air purification beds 34 may be used in the system 100. In some embodiments, air purification beds 34 include solid adsorbent. The solid adsorbent may adsorb H₂O and CO₂. In some embodiments, the solid adsorbent has a higher affinity for H₂O than CO₂. In this embodiment, the solid adsorbent may selectively adsorb H₂O before CO₂ because of the difference in affinity. Similarly, the solid adsorbent may selectively desorb CO₂ before H₂O because of the difference in affinity. In some embodiments, the solid adsorbent is selected from a group consisting of alumina, silica gel, molecular sieves, and mixtures thereof. In some embodiments, the first separation zone 18 is a temperature swing adsorption (TSA) zone. In this embodiment, first separation zone 18 may include a plurality of air purification beds 34 which are cycled through various stages of adsorption and desorption, as is well-known in the art and further described in more detail herein.

The first heat exchanger 20 may be used to heat or cool one or more streams in the system 100, as described in more detail herein. In some embodiments, the first heat exchanger 20 may heat a regeneration gas stream, as described in more detail herein. First heat exchanger 20 may be a double-pip heat exchanger, a shell-and-tube heat exchanger, a plate heat exchanger, an adiabatic wheel heat exchanger, a plate fin heat exchanger, a finned tube heat exchanger, a phase change heat exchanger, a waste heat recovery unit, a direct contact heat exchanger, or a combination of one or more of the foregoing. In some embodiments, first heat exchanger 20 may be fluidly connected to turboexpander 22. In some embodiments, turboexpander 22 may increase the efficiency of heat exchanger 20.

Still referring to FIG. 1, the second separation zone 24 may include one or more distillation columns 36. The distillation column 36 may include a plurality of distillation plates (not shown in FIG. 1). In some embodiments, distillation column 36 may be fluidly connected one or more auxiliary components well-known in the art to aid in operation of distillation column 36, including, but not limited to, a reboiler, a condenser, a knock-out drum, a reflux drum, a pump, and so forth.

In some embodiments, N₂ enriched stream 74 leaves the second separation zone 324 as a cryogenic liquid. The N₂ enriched stream 74 may be combined with N₂ enriched by product stream 90. The N₂ enriched stream 74 may be passed to first heat exchanger 20, second heat exchanger 30, or cooler 14, or any heat exchanger or cooler not shown in FIG. 1 to cool one or more streams in system 100.

In some embodiments, the second separation zone 24 is a cryogenic distillation separation zone. In this embodiment, second separation zone 24 operates at sub-zero temperatures. To prevent water and CO₂ freezing in distillation column 36, any air stream entering column 36 must be substantially free of water and CO₂. By a stream being “substantially free of water” it is meant that the stream comprises less than 0.1 ppm of water.

System 100 may include a first heating zone 26. Heating zone 26 may heat one or more streams in system 100. In some embodiments, heating zone 26 may heat a stream leaving the first heat exchanger 20, as described in more detail herein. In other embodiments, heating zone 26 may heat a stream leaving the second separation zone 18. Heating zone 26 may include one or more heaters (not shown in FIG. 1). In some embodiments, the one or more heaters is selected from a group consisting of a flanged heater, a circulation heater, an over-the-side heater, a screw-plug heater, a duct heater, a pipe heater, a line heater, or a combination of one or more of the foregoing. Alternatively, or additionally, heating zone 26 may be a heat exchanger.

Still referring to FIG. 1, system 100 may include drying zone 28. Drying zone 28 may remove H₂O from a stream. In some embodiments, drying zone 28 may dry a stream leaving the second separation zone 18. Drying zone 28 may include one or more dryers (not shown in FIG. 1). In some embodiments, the one or more dryers is selected from alumina, silica gel, molecular sieves, or a combination of one or more of the foregoing.

System 100 may include a second heat exchanger 30. The second heat exchanger 30 may be used to heat or cool one or more streams in the system 100, as described in more detail herein. The second heat exchanger 30 may be of the type of heat exchanger described herein.

As shown in FIG. 1, system 100 may include a third separation zone 32. The third separation zone 32 may include one or more columns 38. In one embodiment, column 38 may be a distillation column including a plurality of distillation plates (not shown in FIG. 1). In embodiments where column 38 is a distillation column, column 38 may be fluidly connected one or more auxiliary components well-known in the art to aid in operation of a distillation column.

In some embodiments, the third separation zone 32 is a cryogenic distillation separation zone. In this embodiment, second separation zone 24 operates at sub-zero temperatures. To prevent water freezing in distillation column 36, any air stream entering column 36 must be substantially free of water. By a stream being “substantially free of water” it is meant that the stream comprises less than 0.1 ppm of water. In this embodiment, N₂ enriched by product stream 90 may leave third separation zone 32 as a cryogenic liquid. The N₂ enriched by product stream 90 may be combined with N₂ enriched stream 74. The N₂ enriched by product stream 90 may be passed to first heat exchanger 20, second heat exchanger 30, or cooler 14, or any heat exchanger or cooler not shown in FIG. 1 to cool one or more streams in system 100. The CO₂ enriched stream may also leave third separation zone 32 as a cryogenic liquid.

In another embodiment, third separation zone 32 is a pressure swing adsorption (PSA) zone. The third separation zone 32 may include a column 38. In some embodiments, column 38 includes solid adsorbent. In some embodiments, the solid adsorbent is selected from a group consisting of alumina, silica gel, molecular sieves, activated carbon, and mixtures of one or more of the foregoing.

Turning now to FIG. 2, an exemplary embodiment of a first separation zone 200. In this embodiment, first separation zone 200 is a TSA and the solid adsorbent is a regenerative solid adsorbent. In this embodiment, an air stream 268 enters one or more air purification beds 234 including solid adsorbent. The solid adsorbent has a higher affinity for H₂O than CO₂ and adsorbs CO₂ first and H₂O second from air stream 268. A CO₂ and H₂O depleted gas stream 270 exiting air purification beds 234 has reduced concentrations of CO₂ and H₂O. In some embodiments, stream 270 is substantially free of CO₂ and H₂O. By stream 270 being “substantially free of CO₂ and H₂O” it is meant stream 270 contains less than 1 ppm CO₂ and less than 0.1 ppm H₂O. When the solid adsorbent in air purification beds 234 requires regeneration, air purification beds 234 receive a heated N₂ enriched regeneration stream 282 from the second separation zone via stream 280 (not shown). As the heated N₂ enriched regeneration stream 282 is passed through the solid adsorbent, the solid adsorbent selectively desorbs CO₂ first and H₂O second because of the difference in affinity. After the regeneration of the solid adsorbent, a spent regeneration gas stream 284 exits air purification beds 234. A portion of the spent regeneration gas stream 284 is recycled back to air purification beds 234 via stream 285 optionally after mixing with stream 280. Depending on whether the CO₂ concentration of the remaining portion of the spent regeneration gas stream 284 is at, above, or below a predetermined level, the spent regeneration gas stream 284 is either passed to the third separation zone (not shown) via stream 287 or is passed to a further downstream process (not shown) via stream 294, as described in more detail herein.

Referring back to FIG. 1, system 100 may be used in a process to provide a CO₂ enriched stream 92 from an air stream 60. In this embodiment, air stream 60 may be passed to an inlet air filter 10 to remove undesirable contaminants present in air stream 60. The filtered stream 62 may be passed to air compressor 12 to compress stream 62 to a predetermined pressure. The compressed stream 64 may be passed to cooler 14 to reduce the temperature of the compressed stream 64. The cooled stream 66 may be passed to water separator 16 to remove liquid water from the cooled stream 66. The liquid-free stream 68 may be passed to the first separation zone 18 to selectively adsorb CO₂ and H₂O from dehydrated stream 68. The CO₂ and H₂O depleted stream 70 may be passed to first heat exchanger 20 to cool CO₂ and H₂O depleted stream 70. The cooled CO₂ and H₂O depleted stream 72 may be passed to second separation zone 24. Second separation zone 24 may provide an N₂ enriched stream 74, an O₂ enriched stream 76, and an N₂ enriched regeneration stream 78, as described in more detail herein. The N₂ enriched regeneration stream 78 may be passed to first heat exchanger 20 to preheat the N₂ enriched regeneration stream 78. The preheated the N₂ enriched regeneration stream 80 may be passed to first heater 26 so it may heated to a predetermined temperature suitable for desorbing the solid adsorbent in first separation zone 18. The heated N₂ enriched regeneration stream 82 may be passed to the first separation zone 18 to selectively desorb CO₂ and H₂O from the solid adsorbent.

Because the solid adsorbent in the first separation zone 18 has a higher affinity for H₂O than CO₂, CO₂ will be desorbed first. At this time, the spent regeneration gas stream 84 leaving the first separation zone 18 may include the desorbed CO₂ and N₂ from the heated N₂ enriched regeneration stream 82, as described in more detail herein. When the spent regeneration gas stream 84 has a concentration of CO₂ that is at or above a predetermined level, as described in more detail herein, the spent regeneration gas stream 84 may be passed to dryer 28 to remove any desorbed H₂O and provide a dried spent regeneration gas stream 86. The dried spent regeneration gas stream 86 may be passed to second heat exchanger 30 to cool the dried spent regeneration gas stream 86. The cooled spent regeneration gas stream 88 leaving second heat exchanger 30 may be passed to the third separation zone 32. The third separation zone 32 may separate the cooled spent regeneration gas stream 88 into a CO₂ enriched stream 92 and a N₂ enriched byproduct stream 90. In some embodiments, the CO₂ enriched stream 92 is a liquefied CO₂ enriched stream. In some embodiments, N₂ enriched byproduct stream 90 is a liquefied N₂ enriched stream.

At some point in time, the concentration of CO₂ in the spent regeneration gas stream 84 will decrease below a predetermined level because the majority of the CO₂ has already been desorbed from the solid adsorbent. At this time, the spent regeneration gas stream 84 leaving the first separation zone 18 may include the desorbed H₂O and N₂ from the heated N₂ enriched regeneration stream 82. To prevent H₂O from entering the third separation zone 32, the spent regeneration gas stream 84 will be passed via stream 94 to a further downstream process (not shown).

### EXPERIMENTS

Turning now to FIG. 3, using a process simulation software and input of commercial field data on different applications such as APPU and Natural Gas units, the concentration of CO₂ and H₂O in spent regeneration gas stream 84 over time. In this experimental computer simulation, CO₂ and H₂O are desorbed from a solid adsorbent which has a higher affinity for H₂O than CO₂. As shown in FIG. 3, the majority of CO₂ is desorbed before H₂O is desorbed from the solid adsorbent.

### SPECIFIC EMBODIMENTS

While the following is described in conjunction with specific embodiments, it will be understood that this description is intended to illustrate and not limit the scope of the preceding description and the appended claims.

A first embodiment of the invention is a process of providing a CO₂ enriched stream from an air stream, the process comprising selectively adsorbing, in a first separation zone, CO₂ and H₂O in an air stream and providing a CO₂ and H₂O depleted gas stream; separating, in a second separation zone, the CO₂ and H₂O depleted gas stream and providing an N₂ enriched stream, an O₂ enriched stream, and an N₂ enriched regeneration stream; heating the N₂ enriched regeneration stream to provide a heated N₂ enriched regeneration stream; selectively desorbing, in the first separation zone, the CO₂ and H₂O using the heated N₂ enriched regeneration stream and providing a spent regeneration gas stream; drying the spent regeneration gas stream to remove H₂O and providing a dried spent regeneration gas stream; and separating, in a third separation zone, the CO₂ from the dried spent regeneration gas stream to provide a CO₂ enriched stream. An embodiment of the invention is one, any or all of prior embodiments in this paragraph up through the first embodiment in this paragraph, further comprising cooling the dried spent regeneration gas stream using one or more streams from the second separation zone, the one or more streams having a temperature lower than the dried spent regeneration gas stream. An embodiment of the invention is one, any or all of prior embodiments in this paragraph up through the first embodiment in this paragraph, wherein the first separation zone is a temperature swing adsorption (TSA) zone including solid adsorbent. An embodiment of the invention is one, any or all of prior embodiments in this paragraph up through the first embodiment in this paragraph, wherein the solid adsorbent has a higher affinity for H₂O than CO₂. An embodiment of the invention is one, any or all of prior embodiments in this paragraph up through the first embodiment in this paragraph, wherein the solid adsorbent is selected from a group consisting of alumina, silica gel, molecular sieves, and mixtures thereof. An embodiment of the invention is one, any or all of prior embodiments in this paragraph up through the first embodiment in this paragraph, wherein the second separation zone comprises one or more distillation columns. An embodiment of the invention is one, any or all of prior embodiments in this paragraph up through the first embodiment in this paragraph, wherein the third separation zone is a pressure swing adsorption (PSA) zone. An embodiment of the invention is one, any or all of prior embodiments in this paragraph up through the first embodiment in this paragraph, wherein the third separation zone comprises one or more distillation columns. An embodiment of the invention is one, any or all of prior embodiments in this paragraph up through the first embodiment in this paragraph, further comprising liquefying the CO₂ enriched stream in the third separation zone. An embodiment of the invention is one, any or all of prior embodiments in this paragraph up through the first embodiment in this paragraph, further comprising providing an N2 enriched byproduct stream in the third separation zone. An embodiment of the invention is one, any or all of prior embodiments in this paragraph up through the first embodiment in this paragraph, further comprising the steps of determining when a CO₂ concentration of the spent regeneration gas stream is at a predetermined level, and passing the spent regeneration gas stream to a further downstream process when the CO₂ concentration of the spent regeneration gas stream is at the predetermined level.

A second embodiment of the invention is a process of providing a CO₂ enriched stream from an air stream, the process comprising passing an air stream to a first separation zone configured to selectively adsorb CO₂ and H₂O and provide a CO₂ and H₂O depleted gas stream; passing the CO₂ and H₂O depleted gas stream to a second separation zone configured to provide an N₂ enriched stream, an O₂ enriched stream, and an N₂ enriched regeneration stream; passing the N₂ enriched regeneration stream to a first heating zone to provide a heated N₂ enriched regeneration stream; passing the heated N₂ enriched regeneration stream to the first separation zone, the first separation zone further configured to selectively desorb the CO₂ and H₂O and provide a spent regeneration gas stream; passing the spent regeneration gas stream to a drying zone configured to remove H₂O and provide a dried spent regeneration gas stream; and passing the dried spent regeneration gas stream to a third separation zone configured to provide a CO₂ enriched stream. An embodiment of the invention is one, any or all of prior embodiments in this paragraph up through the second embodiment in this paragraph, further comprising passing one or more streams from the second separation zone to a first heat exchanger, the first heat exchanger configured to cool the dried spent regeneration gas stream. An embodiment of the invention is one, any or all of prior embodiments in this paragraph up through the second embodiment in this paragraph, wherein the first separation zone is a temperature swing adsorption (TSA) zone including a solid adsorbent. An embodiment of the invention is one, any or all of prior embodiments in this paragraph up through the second embodiment in this paragraph, wherein the third separation zone is further configured to provide a liquefied CO₂ enriched stream. An embodiment of the invention is one, any or all of prior embodiments in this paragraph up through the second embodiment in this paragraph, wherein the third separation zone is a pressure swing adsorption (PSA) zone. An embodiment of the invention is one, any or all of prior embodiments in this paragraph up through the second embodiment in this paragraph, wherein the third separation zone is further configured to provide an N₂ enriched byproduct stream.

A third embodiment of the invention is a system for producing a CO₂ enriched stream from an air stream, the system comprising a first separation zone configured to receive an air stream and selectively adsorb CO₂ and H₂O and provide a CO₂ and H₂O depleted gas stream; a second separation zone configured to receive the CO₂ and H₂O depleted gas stream and provide an N₂ enriched stream, an O₂ enriched stream, and an N₂ enriched regeneration stream; a first heater configured to heat the N₂ enriched regeneration stream; the first separation zone further configured to receive the heated N₂ enriched regeneration stream to selectively desorb the CO₂ and H₂O and provide a spent regeneration gas stream; a dryer configured to receive the spent regeneration gas stream to remove H₂O and provide a dried spent regeneration gas stream; a third separation zone configured to receive the dried spent regeneration gas stream and provide a CO₂ enriched stream. An embodiment of the invention is one, any or all of prior embodiments in this paragraph up through the third embodiment in this paragraph, further comprising a first heat exchanger configured to receive one or more streams from the second separation zone and cool the dried spent regeneration gas stream. An embodiment of the invention is one, any or all of prior embodiments in this paragraph up through the third embodiment in this paragraph, wherein the first separation zone is a temperature swing adsorption (TSA) zone including a solid adsorbent. An embodiment of the invention is one, any or all of prior embodiments in this paragraph up through the third embodiment in this paragraph, wherein the third separation zone is further configured to provide a liquefied CO₂ enriched stream. An embodiment of the invention is one, any or all of prior embodiments in this paragraph up through the third embodiment in this paragraph, wherein the third separation zone is a pressure swing adsorption (PSA) zone. An embodiment of the invention is one, any or all of prior embodiments in this paragraph up through the third embodiment in this paragraph, wherein the third separation zone is further configured to provide an N₂ enriched byproduct stream.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process of providing a CO₂ enriched stream from an air stream, the process comprising:
selectively adsorbing, in a first separation zone, CO₂ and H₂O in an air stream and providing a CO₂ and H₂O depleted gas stream;
separating, in a second separation zone, the CO₂ and H₂O depleted gas stream and providing an N₂ enriched stream, an O₂ enriched stream, and an N₂ enriched regeneration stream;
heating the N₂ enriched regeneration stream to provide a heated N₂ enriched regeneration stream;
selectively desorbing, in the first separation zone, the CO₂ and H₂O using the heated N₂ enriched regeneration stream and providing a spent regeneration gas stream;
drying the spent regeneration gas stream to remove H₂O and providing a dried spent regeneration gas stream; and
separating, in a third separation zone, the CO₂ from the dried spent regeneration gas stream to provide a CO₂ enriched stream.

2. The process of claim 1, further comprising cooling the dried spent regeneration gas stream using one or more streams from the second separation zone, the one or more streams having a temperature lower than the dried spent regeneration gas stream.

3. The process of claim 1, wherein the first separation zone is a temperature swing adsorption (TSA) zone including solid adsorbent.

4. The process of claim 3, wherein the solid adsorbent has a higher affinity for H₂O than CO₂.

5. The process of claim 4, wherein the solid adsorbent is selected from a group consisting of alumina, silica gel, molecular sieves, and mixtures thereof.

6. The process of claim 1, wherein the second separation zone comprises one or more distillation columns.

7. The process of claim 1, wherein the third separation zone is a pressure swing adsorption (PSA) zone.

8. The process of claim 1, wherein the third separation zone comprises one or more distillation columns.

9. The process of claim 1, further comprising liquefying the CO₂ enriched stream in the third separation zone.

10. The process of claim 1, further comprising providing an N₂ enriched byproduct stream in the third separation zone.

11. The process of claim 1, further comprising the steps of
determining when a CO₂ concentration of the spent regeneration gas stream is at a predetermined level, and
passing the spent regeneration gas stream to a further downstream process when the CO₂ concentration of the spent regeneration gas stream is at the predetermined level.

12. A process of providing a CO₂ enriched stream from an air stream, the process comprising:
passing an air stream to a first separation zone configured to selectively adsorb CO₂ and H₂O and provide a CO₂ and H₂O depleted gas stream;
passing the CO₂ and H₂O depleted gas stream to a second separation zone configured to provide an N₂ enriched stream, an O₂ enriched stream, and an N₂ enriched regeneration stream;
passing the N₂ enriched regeneration stream to a first heating zone to provide a heated N₂ enriched regeneration stream;
passing the heated N₂ enriched regeneration stream to the first separation zone, the first separation zone further configured to selectively desorb the CO₂ and H₂O and provide a spent regeneration gas stream;
passing the spent regeneration gas stream to a drying zone configured to remove H₂O and provide a dried spent regeneration gas stream; and
passing the dried spent regeneration gas stream to a third separation zone configured to provide a CO₂ enriched stream.

13. The process of claim 12, further comprising passing one or more streams from the second separation zone to a first heat exchanger, the first heat exchanger configured to cool the dried spent regeneration gas stream.

14. The process of claim 12, wherein the first separation zone is a temperature swing adsorption (TSA) zone including a solid adsorbent.

15. The process of claim 12, wherein the third separation zone is further configured to provide a liquefied CO₂ enriched stream.

16. The process of claim 12, wherein the third separation zone is a pressure swing adsorption (PSA) zone.

17. The process of claim 12, wherein the third separation zone is further configured to provide an N₂ enriched byproduct stream.

18. A system for producing a CO₂ enriched stream from an air stream, the system comprising:
a first separation zone configured to receive an air stream and selectively adsorb CO₂ and H₂O and provide a CO₂ and H₂O depleted gas stream;
a second separation zone configured to receive the CO₂ and H₂O depleted gas stream and provide an N₂ enriched stream, an O₂ enriched stream, and an N₂ enriched regeneration stream;
a first heater configured to heat the N₂ enriched regeneration stream;
the first separation zone further configured to receive the heated N₂ enriched regeneration stream to selectively desorb the CO₂ and H₂O and provide a spent regeneration gas stream;
a dryer configured to receive the spent regeneration gas stream to remove H₂O and provide a dried spent regeneration gas stream;
a third separation zone configured to receive the dried spent regeneration gas stream and provide a CO₂ enriched stream.

19. The system of claim 18, further comprising a first heat exchanger configured to receive one or more streams from the second separation zone and cool the dried spent regeneration gas stream.

20. The system of claim 18, wherein the first separation zone is a temperature swing adsorption (TSA) zone including a solid adsorbent, or
wherein the third separation zone is further configured to provide a liquefied CO₂ enriched stream, or
wherein the third separation zone is a pressure swing adsorption (PSA) zone, or
wherein the third separation zone is further configured to provide an N₂ enriched byproduct stream, or
any combination thereof.
